(19) United States
(12) Patent Application Publication
(10) Pub. No.: US 2018/0321547 A1
(43) Pub. Date: Nov. 8, 2018

(54) COLOR FILTER SUBSTRATE STRUCTURE AND LIQUID CRYSTAL DISPLAY (LCD) USING THE SAME

(71) Applicant: SHENZHEN CHINA STAR OPTOELECTRONICS TECHNOLOGY CO., LTD., Shenzhen (CN)

(72) Inventor: Wenhui Li, Shenzhen (CN)

(21) Appl. No.: 15/022,403

(22) PCT Filed: Feb. 26, 2016
(86) PCT No.: PCT/CN2016/074691

§ 371 Date: Mar. 16, 2016

(30) Foreign Application Priority Data
Jan. 26, 2016 (CN) 201610055127.2

(51) Int. Cl. G02F 1/1335; G02F 1/1368; G02F 1/1345

(52) U.S. Cl. CPC G02F 1/133514; G02F 1/133512; G02F 2201/121; G02F 1/1345; G02F 1/1368

(57) ABSTRACT

A color filter substrate structure and an LCD using the same are described. The color filter substrate structure comprises a substrate; an auxiliary conducting layer disposed on the substrate and comprising a plurality of conducting contact pads wherein the conducting contact pads are composed of opaque material for differentiating a plurality of different color units of a sub-pixel primary color layer and each conducting contact pad is electrically connected to a common electrode layer; the sub-pixel primary color layer comprising a red unit, a green unit and a blue unit wherein the conducting contact pads of the auxiliary conducting layer are used to differentiate the red unit, the green unit and the blue unit respectively; and the common electrode layer disposed on the auxiliary conducting layer and the sub-pixel primary color layer for electrically connecting the conducting contact pads of the auxiliary conducting layer.

### BACKGROUND OF THE INVENTION

### Field of Invention

The present invention relates to a technical field of a liquid crystal display (LCD), and more particularly to a color filter substrate structure and an LCD using the same.

### Description of Prior Art

Since the LCD is provided with the features of low radiation, small size and low power consumption for consumers, therefore, the conventional display unit with cathode ray tube is increasingly replaced by the LCD. An LCD panel is widely used in communication products including a notebook computer, a personal digital assistant (PDA), a flat panel television and mobile phone.

The LCD includes a thin film transistor (TFT) substrate and a color filter substrate, i.e. a color filter film. Conventionally, the color filter substrate comprises a black matrix (BM) layer, a color layer, a common electrode layer and a photo spacer (PS) layer wherein a driving voltage transmitted to the common electrode layer and the voltage added to the pixel electrodes of the TFT substrate form an electrical field therebetween and the electrical field can be adjusted to by controlling the voltage to modulate the twist angle of the liquid crystal and the light transmission rate.

Currently, the display size of LCD becomes large, e.g. the sizes 55, 65, 85 and 110 inches. However, since the common electrode layer is a transparent electrode layer covering the whole color layer in the LCD with a large size, the resistance of the transparent electrode layer is too large and thus the conducting power is poor. Furthermore, when the LCD size is increased, the applied voltage in the central portion and the edge portion of the LCD panel is not uniform to downgrade the display quality of the LCD display unit. Consequently, there is a need to develop a novel color filter substrate to solve the problems of the conventional technique.

### SUMMARY OF THE INVENTION

Therefore, one objective of the present invention is to provide a color filter substrate structure and an LCD using the same to utilize an electrical connection between the auxiliary conducting layer and the common electrode layer to increase the conductive power of the color filter substrate structure to equalize the voltage within the color filter substrate structure to uniform the brightness of the light and to improve the display quality of the LCD.

Based on the above objective, one embodiment of the present invention sets forth a color filter substrate structure which is applicable to an LCD panel. The color filter substrate structure comprises a substrate; an auxiliary conducting layer disposed on the substrate and comprising a plurality of conducting contact pads wherein the conducting contact pads are composed of opaque material for differentiating a plurality of different color units of a sub-pixel primary color layer and each conducting contact pad is electrically connected to a common electrode layer; the sub-pixel primary color layer comprising a red unit, a green unit and a blue unit wherein the conducting contact pads of the auxiliary conducting layer are used to differentiate the red unit, the green unit and the blue unit respectively; and the common electrode layer disposed on the auxiliary conducting layer and the sub-pixel primary color layer for electrically connecting the conducting contact pads of the auxiliary conducting layer.

In one embodiment, the color filter substrate structure further comprises a black matrix layer disposed between the substrate and the auxiliary conducting layer wherein the auxiliary conducting layer is disposed on the surface of the black matrix layer for electrically connecting the common electrode layer to the auxiliary conducting layer on the black matrix layer.

In one embodiment, the black matrix layer further comprises a plurality of via holes and the conducting contact pads of the auxiliary conducting layer are correspondingly plugged into the via holes for electrically connecting the common electrode layer to the conducting contact pads within the via holes.

In one embodiment, the material of auxiliary conducting layer is selected from one group consisting of polymer material, conductive silver paste, metal, conductive oxide and graphene film.

In one embodiment, an electrical conductivity of the auxiliary conducting layer is greater than an electrical conductivity of the black matrix layer.

Another embodiment of the present invention sets forth a color filter substrate structure which is applicable to an LCD panel wherein the color filter substrate structure is arranged opposite the LCD panel. The color filter substrate structure comprises a substrate; an auxiliary conducting layer disposed on the substrate and comprising a plurality of conducting contact pads wherein each conducting contact pad is electrically connected to a common electrode layer; a black matrix layer disposed on a thin film transistor (TFT) substrate for differentiating a plurality of different color units of a sub-pixel primary color layer; the sub-pixel primary color layer disposed on the TFT substrate and comprising a red unit, a green unit and a blue unit wherein the black matrix layer are used to differentiate the red unit, the green unit and the blue unit respectively; and the common electrode layer disposed on the auxiliary conducting layer for electrically connecting the conducting contact pads of the auxiliary conducting layer.

In one embodiment, the material of auxiliary conducting layer is selected from one group consisting of polymer material, conductive silver paste, metal, conductive oxide and graphene film.

In one embodiment, when the auxiliary conducting layer is composed of opaque material, the auxiliary conducting layer aligns the black matrix layer, and when the auxiliary conducting layer is composed of transparent material, the auxiliary conducting layer either aligns or does not align the black matrix layer.

In one embodiment, an electrical conductivity of the auxiliary conducting layer is greater than an electrical conductivity of the black matrix layer.

In still another embodiment of the present invention, an LCD display unit comprises a color filter substrate structure in the above-mentioned descriptions.

### BRIEF DESCRIPTION OF THE DRAWINGS

FIG. 1 is a schematic view of a color filter substrate structure of an LCD display unit according to a first embodiment of the present invention;

FIG. 2 is a schematic view of a color filter substrate structure of an LCD display unit according to a second embodiment of the present invention;

FIG. 3 is a schematic view of a color filter substrate structure of an LCD display unit according to a third embodiment of the present invention; and

FIG. 4 is a schematic view of a color filter substrate structure of an LCD display unit according to a fourth embodiment of the present invention.

### DETAILED DESCRIPTION OF THE PREFERRED EMBODIMENTS

The following embodiments refer to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the drawings, the same reference symbol represents the same or a similar component.

Please refer to FIG. 1, which is a schematic view of a color filter substrate structure of an LCD display unit according to a first embodiment of the present invention. The color filter substrate structure is applicable to an LCD panel and comprises a substrate 100, an auxiliary conducting layer 102, a sub-pixel primary color layer 104 and a common electrode layer 106 wherein the substrate 100 comprise a glass substrate.

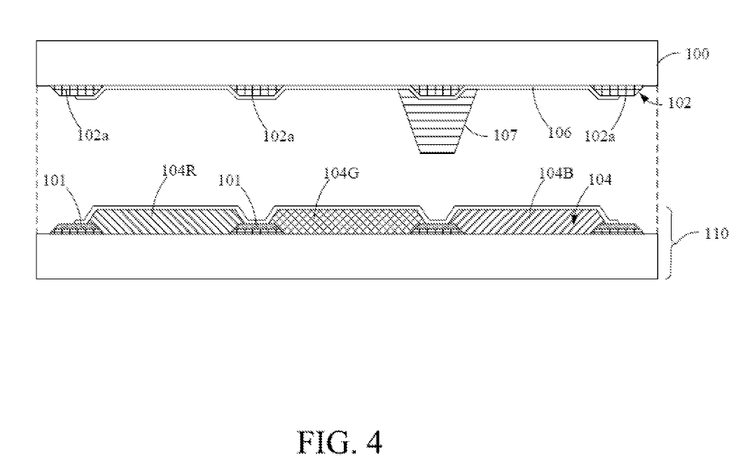

In FIG. 1, the auxiliary conducting layer 102 is disposed on the substrate 100 and comprises a plurality of conducting contact pads 102a which are composed of opaque material for differentiating the different color units of the sub-pixel primary color layer 104 wherein each conducting contact pad 102a is electrically connected to the common electrode layer 106. In one embodiment, the electrical conductivity of the auxiliary conducting layer 102 is greater than electrical conductivity of conventional black matrix and the auxiliary conducting layer 102 serves as the function of shielding the light from the backlight for separating the different color units of the sub-pixel primary color layer 104 in order to increase the contrast ratio and prevent the photo-current. In other words, the material of auxiliary conducting layer 102 in the present invention can replace the conventional black matrix. The material of auxiliary conducting layer 102 is selected from one of polymer material, conductive silver paste, metal, conductive oxides and a graphene film, but not limited. The color filter substrate structure further comprises a plurality of photo spacers 107 for supporting the color filter substrate structure and TFT substrate (shown in FIG. 4).

In FIG. 1, the sub-pixel primary color layer 104 comprises a red unit 104R, a green unit 104G and a blue unit 104B. The conducting contact pads 102a of the auxiliary conducting layer 102 are used to differentiate the red unit 104R, the green unit 104G and the blue unit 104B respectively. The common electrode layer 106 is disposed on the auxiliary conducting layer 102 and the sub-pixel primary color layer 104 and electrically connected to the conducting contact pads 102a of the auxiliary conducting layer 102. In one embodiment, the material of common electrode layer 106 is indium tin oxide (ITO).

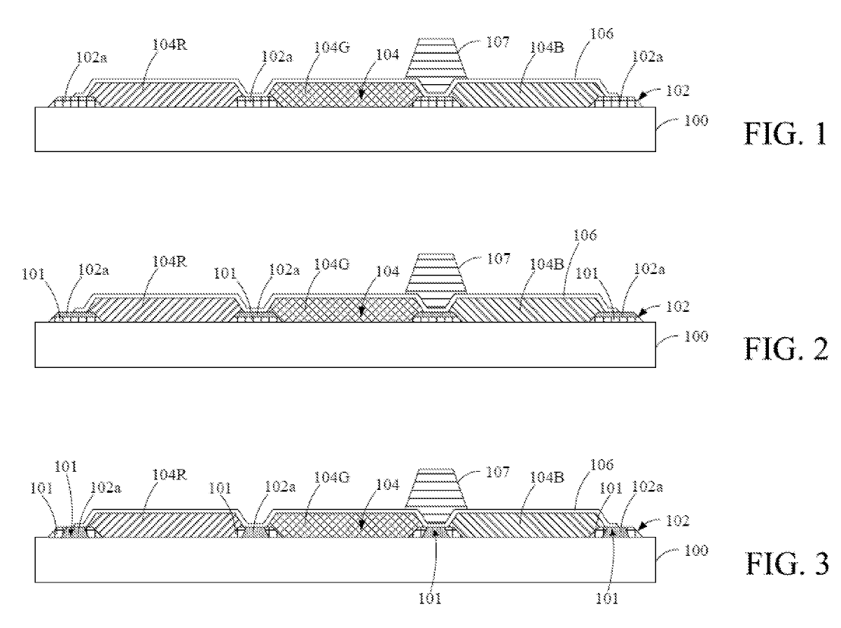

Please refer to FIG. 2, which is a schematic view of a color filter substrate structure of an LCD display unit according to a second embodiment of the present invention. The color filter substrate structure comprises a substrate 100, a black matrix layer 101, an auxiliary conducting layer 102, a sub-pixel primary color layer 104 and a common electrode layer 106 wherein the substrate 100 comprise a glass substrate. The black matrix layer 101 is disposed between the substrate 100 and the auxiliary conducting layer 102. The auxiliary conducting layer 102 is disposed on the surface of the black matrix layer 101 for electrically connecting the common electrode layer 106 to the auxiliary conducting layer 102 on the black matrix layer 101.

In FIG. 2, the auxiliary conducting layer 102 is disposed on the black matrix layer 101 and comprises a plurality of conducting contact pads 102a which are composed of opaque material for differentiating the different color units of the sub-pixel primary color layer 104 wherein each conducting contact pad 102a is electrically connected to the common electrode layer 106. In one embodiment, the electrical conductivity of the auxiliary conducting layer 102 is greater than electrical conductivity of the black matrix layer 101 and the black matrix layer 101 serves as the function of shielding the light from the backlight for separating the different color units of the sub-pixel primary color layer 104 in order to increase the contrast ratio and prevent the photo-current. The material of auxiliary conducting layer 102 is selected from one of polymer material, conductive silver paste, metal, conductive oxides and a graphene film, but not limited.

In FIG. 2, the sub-pixel primary color layer 104 comprises a red unit 104R, a green unit 104G and a blue unit 104B. The conducting contact pads 102a of the auxiliary conducting layer 102 are used to differentiate the red unit 104R, the green unit 104G and the blue unit 104B respectively. The common electrode layer 106 is disposed on the auxiliary conducting layer 102 and the sub-pixel primary color layer 104 and electrically connected to the conducting contact pads 102a of the auxiliary conducting layer 102. In one embodiment, the material of common electrode layer 106 is indium tin oxide (ITO).

Please refer to FIG. 3, which is a schematic view of a color filter substrate structure of an LCD display unit according to a third embodiment of the present invention. The color filter substrate structure of an LCD display unit in the third embodiment is similar to a color filter substrate structure of an LCD display unit in the second embodiment. The difference is that the black matrix layer 101 comprises a plurality of via holes 108 and the conducting contact pads 102a of the auxiliary conducting layer 102 are correspondingly plugged into the via holes 108 for electrically connecting the common electrode layer 106 to the conducting contact pads 102a within the via holes 108.

Please refer to FIG. 4, which is a schematic view of a color filter substrate structure of an LCD display unit according to a fourth embodiment of the present invention. The color filter substrate structure is applicable to an LCD panel and comprises a substrate 100, a black matrix layer 101, an auxiliary conducting layer 102, a sub-pixel primary color layer 104 and a common electrode layer 106 wherein the black matrix layer 101 and the sub-pixel primary color layer 104 are disposed on the TFT substrate 110.

In an example of FIG. 4, the substrate 100 substrate 100 comprise a glass substrate. The auxiliary conducting layer 102 is disposed on the substrate 100 and comprises a plurality of conducting contact pads 102a wherein each conducting contact pad 102a is electrically connected to the common electrode layer 106. In one embodiment, the material of auxiliary conducting layer 102 is selected from one of polymer material, conductive silver paste, metal, conductive oxides and a graphene film, but not limited. The black matrix layer 101 is disposed on the TFT substrate 110 for differentiating the red unit 104R, the green unit 104G and the blue unit 104B respectively of the sub-pixel primary color layer 104. In one embodiment, the electrical conductivity of the auxiliary conducting layer 102 is greater than electrical conductivity of the black matrix layer 101. In one case, when the auxiliary conducting layer 102 is composed of opaque material, the auxiliary conducting layer 102 aligns the black matrix layer 101. In another case, when the auxiliary conducting layer 102 is composed of transparent material, the auxiliary conducting layer 102 either aligns or does not align the black matrix layer 101.

In FIG. 4, the sub-pixel primary color layer 104 is disposed on the TFT substrate 110 and comprises a plurality of red units 104R, green units 104G and blue units 104B. The black matrix layer 101 is used to differentiate the red units 104R, green units 104G and blue units 104B. The common electrode 106 is disposed on the auxiliary conducting layer 102 for electrically connecting the conducting contact pads 102a of the auxiliary conducting layer 102.

In another embodiment, the present invention provides an LCD using the above-mentioned descriptions.

The color filter substrate structure and an LCD using the same in the present invention utilizes an electrical connection between the auxiliary conducting layer and the common electrode layer to increase the conductive power of the color filter substrate structure to equalize the voltage within the color filter substrate structure to uniform the brightness of the light and to improve the display quality of the LCD. In other words, the color filter substrate structure in the present invention solves the problems of the larger resistance of the common electrode layer and the uneven applied voltage in the central portion and the edge portion of the large size of LCD panel, which results in mura effect due to the uneven brightness and chrominance.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A color filter substrate structure which is applicable to an LCD panel, comprising:
a substrate;
an auxiliary conducting layer disposed on the substrate and comprising a plurality of conducting contact pads wherein the conducting contact pads are composed of opaque material for differentiating a plurality of different color units of a sub-pixel primary color layer and each conducting contact pad is electrically connected to a common electrode layer;
the sub-pixel primary color layer comprising a red unit, a green unit and a blue unit wherein the conducting contact pads of the auxiliary conducting layer are used to differentiate the red unit, the green unit and the blue unit respectively; and
the common electrode layer disposed on the auxiliary conducting layer and the sub-pixel primary color layer for electrically connecting the conducting contact pads of the auxiliary conducting layer.

2. The color filter substrate structure of claim 1, further comprising a black matrix layer disposed between the substrate and the auxiliary conducting layer wherein the auxiliary conducting layer is disposed on the surface of the black matrix layer for electrically connecting the common electrode layer to the auxiliary conducting layer on the black matrix layer.

3. The color filter substrate structure of claim 2, wherein the black matrix layer further comprises a plurality of via holes and the conducting contact pads of the auxiliary conducting layer are correspondingly plugged into the via holes for electrically connecting the common electrode layer to the conducting contact pads within the via holes.

4. The color filter substrate structure of claim 2, wherein the material of auxiliary conducting layer is selected from one group consisting of polymer material, conductive silver paste, metal, conductive oxide and graphene film.

5. The color filter substrate structure of claim 2, wherein an electrical conductivity of the auxiliary conducting layer is greater than an electrical conductivity of the black matrix layer.

6. A color filter substrate structure which is applicable to an LCD panel, wherein the color filter substrate structure is arranged opposite the LCD panel, the color filter substrate structure comprising:
a substrate;
an auxiliary conducting layer disposed on the substrate and comprising a plurality of conducting contact pads wherein each conducting contact pad is electrically connected to a common electrode layer;
a black matrix layer disposed on a thin film transistor (TFT) substrate for differentiating a plurality of different color units of a sub-pixel primary color layer;
the sub-pixel primary color layer disposed on the TFT substrate and comprising a red unit, a green unit and a blue unit wherein the black matrix layer are used to differentiate the red unit, the green unit and the blue unit respectively; and
the common electrode layer disposed on the auxiliary conducting layer for electrically connecting the conducting contact pads of the auxiliary conducting layer.

7. The color filter substrate structure of claim 6, wherein the material of auxiliary conducting layer is selected from one group consisting of polymer material, conductive silver paste, metal, conductive oxide and graphene film.

8. The color filter substrate structure of claim 6, wherein when the auxiliary conducting layer is composed of opaque material, the auxiliary conducting layer aligns the black matrix layer, and when the auxiliary conducting layer is composed of transparent material, the auxiliary conducting layer either aligns or does not align the black matrix layer.

9. The color filter substrate structure of claim 6, wherein an electrical conductivity of the auxiliary conducting layer is greater than an electrical conductivity of the black matrix layer.

10. An LCD display unit, comprising a color filter substrate structure described in the claim 1.
